(19) United States
(12) Patent Application Publication
(10) Pub. No.: US 2021/0206287 A1
(43) Pub. Date: Jul. 8, 2021

(54) Modulated dual plug-in chargeable and battery swappable electric vehicles

(71) Applicant: Yonghua Wang, Klamath Falls, OR (US)

(72) Inventor: Yonghua Wang, Klamath Falls, OR (US)

(21) Appl. No.: 16/602,982

(22) Filed: Jan. 8, 2020

(51) Int. Cl. B60L 53/80; B60L 53/16

(52) U.S. Cl. CPC B60L 53/80; B60L 2200/36; B60L 53/16

(57) ABSTRACT

A modulated dual plug-in charging and battery swapping electric vehicle comprises an electric vehicle module which can be plug-in charged and a battery swapping module, wherein, the entire battery swapping module is swapped to realize battery swapping. The battery swapping module can attach to the electric vehicle module through clutch or detached from the electric vehicle module. The battery swapping model contains an onboard charger and a battery pack. The battery swapping module can charge the electric vehicle module when they are driving together. The battery swapping module can be made into a truck carriage, when it is attached to the electric vehicle module, the entire system is turned into a pickup truck.

### TECHNICAL FIELD

The present disclosure relates generally to electric vehicle, more specifically, to a modulated dual plug-in chargeable and battery swappable electric vehicle.

### BACKGROUND

The entire world is at the edge of transition from fossil fuel to renewable energy. The automobile industry is accelerating in the process of switching from the internal combustion engine vehicles to electric vehicles. However, due to the lengthy charging time and high cost of electric vehicles, the wide-spread adoption of electric vehicles is hampered. Contrast to fossil fuel, the energy density of battery, which is the core energy carrier of electric vehicle, is only 1/100- 1/200 of that of fossil fuel. The fossil fuel based transportation system is a central system, in which the rode oil is explored and refined centrally, then distributed to gas stations. All internal combustion engine vehicles get their energy replenished at the gas stations. Since the fossil fuel has high energy density, there are no issues in transporting and distributing the fossil fuel. There are no issues either for the internal engine vehicles to carry the energy for long distance and get the energy replenished at the gas stations conveniently. While, due to the low energy density of battery, electric vehicle has to carry large battery bank to extend its driving range, and that makes electric vehicle expensive and heavy, and large battery bank needs long time to charge.

One of the approaches to address the issue of long time charging is battery swapping. The first concept of battery swapping was proposed and implemented by Shai Agassi, CEO and founder of Better Place an Israel company. In which, the entire battery bank of electric vehicle is replaced by robots in a battery swapping station. Due to the high cost of the battery swapping station and the valuable land it occupied, this concept was not widely adopted. However, battery swapping is approved an effective approach in attacking the problem of the lengthy charging time of electric vehicles apart from the other approaches such as fast charging. There should be other novel concepts of battery swapping to mitigate the drawbacks of Shai Agassi's concept.

Currently, all electric vehicles are either designed for plug-in charging or battery swapping. Therefore, the battery bank inside of the electric vehicle is designed as a single entity. The electric vehicle is carrying the entire battery bank for its whole journey. When it needs charging or swapping, the entire battery bank is charged or swapped. In order to extend the driving range, the battery banks of the current electric vehicle are sized in large quantity, consequently, it has the following drawbacks: 1) in a remarkable time of driving, the electric vehicle is carrying a large fraction of empty battery; 2) when in charging, it takes long time to charge the entire battery; 3) when in swapping, it swaps the entire battery bank.

In order to address the fundamental issues the lengthy charging time and the high cost of electric vehicles, the present invention provides a design paradigm that combine the plug-in charging and the battery swapping together to replenish energy for electric vehicles. In the design of the present invention, the battery bank of the conventional electric vehicle is divided into two portions, one is used for plug-in charging, and the other is arranged in an extra module which can be attached or detached to the electric vehicle for battery swapping. In this case, the modulated dual plug-in chargeable and battery swappable electric vehicle can be both charged by plug-in charging and battery swapping. Rather than using battery swapping stations, this type of electric vehicle is able to swap its battery module anywhere without special sites. In the mean while, due to the reduced size of the battery bank, the cost of electric vehicle is reduced.

### SUMMARY

According to the present invention, a modulated dual plug-in chargeable and battery swappable electric vehicle comprising a plug-in charging electric vehicle main module and a battery swapping battery module which can be attached to or detached from the main module, is provided to avoid the lengthy charging time and reduce the cost of electric vehicle. In the electric vehicle described above, the battery bank is divided into two sections, one is located in the main electric vehicle module, and the other is designed onto the battery module, so that the fraction of the battery bank can be changed by swapping the battery module. Since the battery module can be swapped frequently anywhere easily, the sizes of both sections of battery bank can be reduced to save the cost of entire electric vehicle.

The wide-spread adoption of electric vehicles relies on the widely available network of charging stations. However, the construction of the infrastructure of charging station network requires the construction of transmission lines along highways and the retrofitting of existing power grids. The modulated dual plug-in chargeable and battery swappable electric vehicle of the present invention does not need the charging station network, but can still use the existing charging station network. In conjunction with the stabilized solar power generation stations, the present electric vehicles will be charged completely by renewable energy, and the battery module can also serves as the energy storage package for solar power generation station. The present electric vehicle provides a foundation to establish the battery module sharing system to ensure the immediate battery swapping. It also provides the foundation to build up the Internet of things (IOT) of battery module, IOT of electric vehicle, and IOT of solar power generation station. All those IOTs can be merged into one IOT system to coordinate the electric vehicles and charging stations.

Further aspects and advantages of the present invention will become apparent upon consideration of the following description thereof, reference being made of the following drawing.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a schematic demonstration of the configuration and the power train of the modulated dual plug-in charging and battery swapping electric vehicle.

FIG. 2 is an overview of the modulated dual plug-in charging and battery swapping electric vehicle with the battery swapping module as a pickup truck carriage.

### DETAILED DESCRIPTION

Reference will now be made in detail to the present exemplary embodiments, examples of which are illustrated in the accompanying drawings. Wherever possible, the same reference numbers will be used throughout the drawings to refer to the same or like parts.

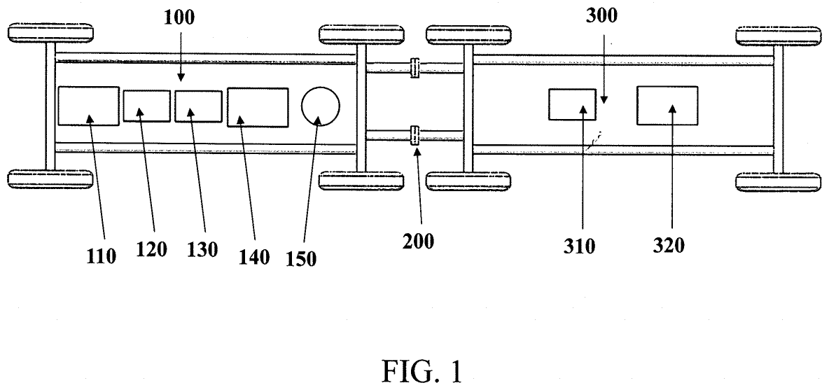

Referring to FIG. 1, the modulated dual plug-in chargeable and battery swappable electric vehicle comprises an electric vehicle module 100 and a battery swapping module 300 which are connected by the clutch 200. The power train of the electric vehicle module consists of the battery pack 110, the converter 120, the inverter 130, the Electronic Control Unit (ECU) and battery management 140, and the electric motor 150. The battery swapping module consists of a battery pack 320 and an onboard electric charger 310 which can charge the battery pack 110 in the electric vehicle module when the entire electric vehicle is moving.

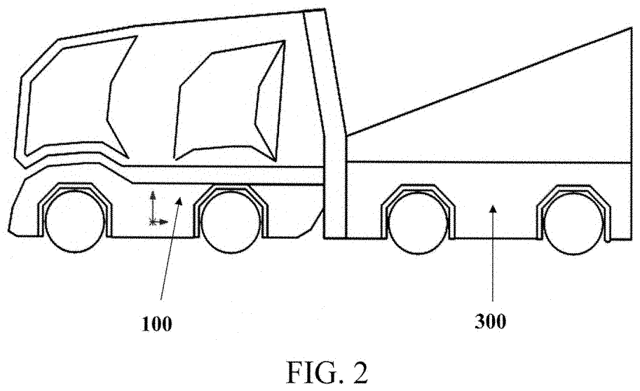

Referring to FIG. 2, the modulated dual plug-in charging and battery swapping electric vehicle is integrated with two modules electric vehicle module 100 and battery swapping module 300. The module 300 can attach to the module 100 and charge the module 300 when it is moving, in this case, the entire electric vehicle becomes a pickup truck. The module 300 can also be detached from the module 100, in this case the module 100 is an independent electric vehicle.

The work principle of the electric vehicle is elucidated as the following: when in operation, the battery swapping module charges the electric vehicle module when they are moving together. After the battery swapping module is exhausted, it can be swapped with fully charged new module or let the electric vehicle drive without battery swapping module. The entire system can be plug-in charged when the charging stations are available and battery swapped when the battery swapping modules are available.

From the description above, a number of advantages of the electric vehicle become evident: 1) the entire electric vehicle system can be both plug-in charged and battery swapped; 2) the battery swapping can happen anywhere without special sites; 3) the battery packs on the boards of electric vehicle module and the battery swapping module can be sized down to save the cost of the entire system; 4) the electric vehicle can be transformed into a pickup truck by attaching the battery swapping module which can be a truck carriage; 5) the weight of the entire electric vehicle system is reduced; 6) the detached battery swapping module can serve as an energy storage for solar power generation system.

In the preceding specification, various preferred embodiments have been described with reference to the accompanying drawings. It will, however, be evident that various other modifications and changes may be made thereto, and additional embodiments may be implemented, without departing from the broader scope of the invention as set forth in the claims that follow. The specification and drawings are accordingly to be regarded in an illustrative rather than restrictive sense.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

I claim:

1. A modulated dual plug-in chargeable and battery swappable electric vehicle, comprising an electric vehicle module and a battery swapping module, which are connected with clutches, and the battery swapping module is able to charge the electric vehicle module,
wherein, the battery swapping module can be attached to and detached from the electric vehicle module, when the battery swapping module is attached to the electric vehicle module, it charge the electric vehicle module; the electric vehicle swaps battery by swapping the entire battery swapping module; the electric vehicle is plug-in charged through the electric vehicle module.

2. The power train of the electric vehicle module of claim 1, consists of a battery pack referred as battery pack 1 of the entire electric vehicle, a converter, a inverter, a electronic control unit and battery management, and a electric motor.

3. The battery swapping module of claim 1, consists of an onboard charger and a battery pack referred as battery pack 2 of the entire electric vehicle.

4. The battery swapping module of claim 3, can charge the battery pack 1 of claim 2.

5. The battery swapping module of claim 3, can be made into a truck carriage.

6. The battery swapping module of claim 5, can be attached to the electric vehicle module of claim 1 to form a pickup truck.
